(19) United States
(12) Patent Application Publication
(10) Pub. No.: US 2025/0335932 A1
(43) Pub. Date: Oct. 30, 2025

(54) INFORMATION PROCESSING METHOD AND NON-TRANSITORY COMPUTER-READABLE STORAGE MEDIUM

(71) Applicant: HONDA MOTOR CO., LTD., Tokyo (JP)

(72) Inventor: Seiichiro KONDO, Tokyo (JP)

(73) Assignee: HONDA MOTOR CO., LTD., Tokyo (JP)

(21) Appl. No.: 19/186,642

(22) Filed: Apr. 23, 2025

(30) Foreign Application Priority Data
Apr. 26, 2024 (JP) 2024-072098

(51) Int. Cl. G06Q 30/018; B60L 53/51; B60L 53/68

(52) U.S. Cl. CPC G06Q 30/018; B60L 53/51; B60L 53/68

(57) ABSTRACT

A computer performs an information processing method of processing information on a carbon credit created by reducing greenhouse gas. The information processing method having a step of generating a charging action candidate including another charging action having an emission amount of the greenhouse gas smaller than that in a reference charging action, in which the charging action candidate is selectable by a user of an electric vehicle, a step of calculating a predicted value of an emission amount of the greenhouse gas discharged by each of the charging actions, and a step of calculating a predicted value of a reduction amount of the greenhouse gas in the another charging action, based on the predicted value of the emission amount of the greenhouse gas in the reference charging action and the predicted value of the emission amount of the greenhouse gas in the another charging action.

### CROSS-REFERENCE TO RELATED APPLICATIONS

This application is based on and claims priority under 35 USC 119 from Japanese Patent Application No. 2024-072098 filed on Apr. 26, 2024, the entire content of which is incorporated herein by reference.

### TECHNICAL FIELD

The present disclosure relates to an information processing method and a non-transitory computer-readable storage medium storing a program, which a computer performs, of processing information on a carbon credit created by reducing greenhouse gas.

### BACKGROUND ART

In recent years, researches and developments have been conducted on renewable energy which contributes to improvement in energy efficiency in order to allow more people to have access to affordable, reliable, sustainable, and advanced energy.

Various countries, regions, and the like operate a greenhouse gas emission trading scheme as a system for promoting a reduction in an emission amount of greenhouse gas such as carbon dioxide (hereinafter also referred to as CO2), which is a cause of global warming. For example, when a company participating in the emission trading scheme reduces the emission amount of the greenhouse gas by introducing a power generation facility or an energy-saving facility using renewable energy such as solar power generation, the company can acquire a carbon credit based on the reduction amount. The carbon credit can be traded with other companies, and for example, can be sold to other companies whose emission amount cannot be sufficiently reduced (for example, JP2003-331088A).

In the emission trading scheme in the related art, many companies having buildings, factories, and the like in which the emission amount of the greenhouse gas is generally large participate. However, as for ordinary households and the like, the emission amount of the greenhouse gas is smaller than that of companies, and acquisition and calculation of authentication data necessary for acquiring the carbon credit are complicated, which is a barrier to participation in the emission trading scheme.

In recent years, an electric vehicle such as an electric automobile equipped with a large-capacity battery for driving has become widespread and is expected as a power resource capable of supplying stored electric power to a home or a power system. There has been a demand for a technique capable of promoting participation in the emission trading scheme even in an ordinary household using such an electric vehicle and contributing to prevention of global warming.

### SUMMARY OF INVENTION

The present disclosure provides an information processing method and a non-transitory computer-readable storage medium storing a program capable of supporting creation of a carbon credit using an electric vehicle and contributing to prevention of global warming. This further contributes to improvement in energy efficiency.

A first aspect of the present disclosure relates to an information processing method, which a computer performs, of processing information on a carbon credit created by reducing greenhouse gas,
the carbon credit being created based on a reduction of the greenhouse gas discharged by a charging action of charging a battery mounted on an electric vehicle by an external power supply, and
the information processing method having:
   generating a charging action candidate including at least one another charging action different from a reference charging action that is a charging action serving as a reference, the at least one another charging action having an emission amount of the greenhouse gas smaller than that in the reference charging action, the charging action candidate being selectable by a user of the electric vehicle;
   calculating a predicted value of an emission amount of the greenhouse gas discharged by each of the charging actions; and
   calculating a predicted value of a reduction amount of the greenhouse gas in each of the at least one another charging action, based on the predicted value of the emission amount of the greenhouse gas in the reference charging action and the predicted value of the emission amount of the greenhouse gas in the another charging action.

A second aspect of the present disclosure relates to a non-transitory computer-readable storage medium storing a program for processing information on a carbon credit created by reducing greenhouse gas, the carbon credit being created based on a reduction of the greenhouse gas discharged by a charging action of charging a battery mounted on an electric vehicle by an external power supply, and
the program causing a computer to perform:
   generating a charging action candidate including at least one another charging action different from a reference charging action that is a charging action serving as a reference, the at least one another charging action having an emission amount of the greenhouse gas smaller than that in the reference charging action, the charging action candidate being selectable by a user of the electric vehicle;
   calculating a predicted value of an emission amount of the greenhouse gas discharged by each of the charging actions; and
   calculating a predicted value of a reduction amount of the greenhouse gas in each of the at least one another charging action, based on the predicted value of the emission amount of the greenhouse gas in the reference charging action and the predicted value of the emission amount of the greenhouse gas in the another charging action.

A third aspect of the present disclosure relates to an information processing method, which a computer performs, of processing information on a carbon credit created by reducing greenhouse gas,
the carbon credit being created based on a reduction of the greenhouse gas discharged by a charging action of charging a battery mounted on each of a plurality of electric vehicles by an external power supply, and
the information processing method having:
   calculating an actual value of a reduction amount of the greenhouse gas for each of users of the plurality of electric vehicles, the actual value of the reduction amount of the greenhouse gas being calculated based on a predicted value of an emission amount of the greenhouse gas in a reference charging action that is a charging action serving as a reference, and an actual value of an emission amount of the greenhouse gas when another charging action having an emission amount of the greenhouse gas smaller than that in the reference charging action is actually performed, and adding up the actual values of the reduction amount of the greenhouse gas;
   performing processing of selling the carbon credit created based on a sum of the actual values of the reduction amount of the greenhouse gas; and
   distributing a part of a profit obtained in the selling of the carbon credit to each of the users.

According to the aspects of the present disclosure, it is possible to support creation of the carbon credit using the electric vehicle and contribute to prevention of global warming.

### BRIEF DESCRIPTION OF DRAWINGS

Exemplary embodiment(s) of the present invention will be described in detail based on the following figures, wherein:

FIG. 1 is a related party correlation diagram summarizing related parties related to creation and trading of a carbon credit;

FIG. 2 is a diagram illustrating an outline of a carbon offset;

FIG. 3 is a block diagram showing a functional configuration of a system 1 including an electric vehicle 10, a terminal device 20, and a server 30;

FIG. 4 shows a schematic diagram (upper side) of a charging action serving as a reference and a graph (lower side) showing an emission amount of CO2 in the charging action serving as the reference;

FIG. 5 illustrates charging options A to C;

FIG. 6 shows charging options D and E;

FIG. 7 is a bar graph showing emission amounts of CO2 and reduction amounts of CO2 in the reference charging action and charging actions in the charging options A to E;

FIG. 8 is an example of a proposal screen of the charging options A to E displayed on the terminal device 20;

FIG. 9 is an example of a screen showing chargeable power amounts in the reference charging action and the charging actions in the charging options A to E displayed on the terminal device 20;

FIG. 10 is a sequence diagram showing an example of processing performed among the server 30, the terminal device 20, and the electric vehicle 10;

FIG. 11 is a control flow showing an example of charging option generation processing performed by the server 30;

FIG. 12 is a control flow showing an example of processing for carbon credit management performed by the server 30; and

FIG. 13 is a sequence diagram showing a modification of the processing performed among the server 30, the terminal device 20, and the electric vehicle 10.

### DESCRIPTION OF EMBODIMENTS

Hereinafter, an information processing method and a program according to an embodiment of the present disclosure will be described with reference to the accompanying drawings.

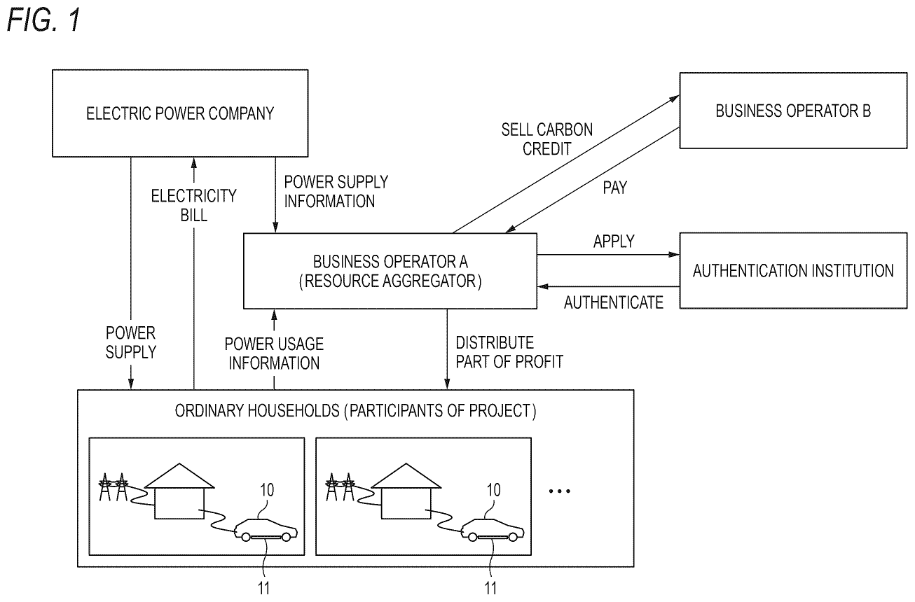

First, an example of a correlation among related parties related to creation and trading of a carbon credit will be described with reference to FIG. 1. As the related parties, for example, an electric power company, an ordinary household, a business operator A, an authentication institution, and a business operator B appear.

The carbon credit is issued by the authentication institution for a project, for reducing emission of greenhouse gas by introducing an energy-saving facility, a renewable energy facility, or the like, as a credit (emission right) such that a difference between a predicted value for an emission amount or the like of the greenhouse gas and an actual emission amount of the greenhouse gas when the project is not performed can be traded between countries, companies, or the like. In the present embodiment, a case where the greenhouse gas is carbon dioxide (CO2) will be described as an example.

The “electric power company” owns, for example, a power generation facility, supplies generated electric power to a power system, and sells the generated electric power to a company, an ordinary household, or the like. The electric power supplied to the power system by the electric power company is electric power generated by various power generation methods such as thermal power generation, nuclear power generation, hydroelectric power generation, and renewable energy. A ratio of each of the power generation methods differs for each electric power company and also differs depending on a time zone.

The “ordinary household” uses the electric power supplied from the power system to each dwelling unit and pays an electricity bill to the electric power company. The “ordinary household” in the present description is described as a plurality of homes each of which owns or uses the electric vehicle 10 equipped with a battery 11 and participates in a project related to carbon credit creation performed by the business operator A.

The electric vehicle 10 is a vehicle that can be charged with electric power from an external power supply, and is, for example, a battery electric automobile, a plug-in hybrid vehicle, a fuel cell vehicle, or the like. For example, an ordinary household participating in the project is provided with a charging equipment allowing normal charging, and the battery 11 of the electric vehicle 10 can be charged at home. As the electric power to be used for charging at home, in addition to the electric power supplied from the power system, when a renewable energy facility such as a solar power generation facility is provided at home, electric power generated by the facility can be used. In the present description, “charging the battery 11” may be referred to as “charging the electric vehicle 10”, and these terms are synonymous.

The “business operator A” is a business operator who creates the carbon credit based on an amount of CO2 reduced in the ordinary household participating in the project, and may also be referred to as a resource aggregator. The business operator A applies for a project related to the carbon credit creation to the authentication institution in advance, and the project is registered as a result of examination by the authentication institution.

The business operator A acquires power usage information (such as charging information) of the electric vehicle 10 for each ordinary household. Although details will be described later, the business operator A aggregates the amount of CO2 reduced by changing a charging action of the electric vehicle 10 in each ordinary household in the entire ordinary households. The business operator A acquires, from the electric power company, power supply information including information such as a usage ratio of renewable energy. The business operator A applies for the carbon credit to the authentication institution based on the reduction amount of CO2 in the entire ordinary households participating in the project.

The “authentication institution” registers the project, and authenticates the application for the carbon credit obtained by execution of the project, and the like. When authenticating the application for the carbon credit from the business operator A, the authentication institution issues the carbon credit to the business operator A. In general, an authentication procedure performed by the authentication institution requires payment of a fee to the authentication institution.

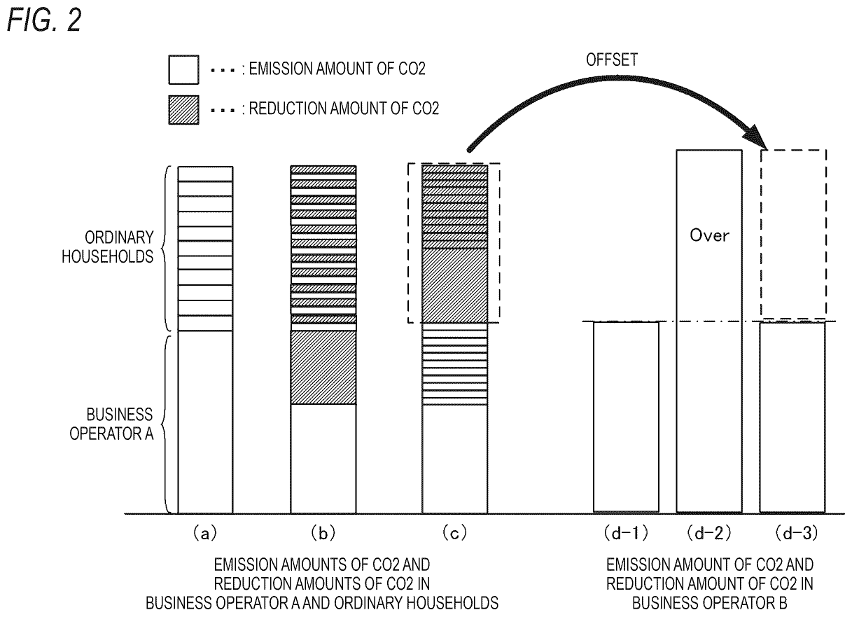

The business operator B is a business operator who desires to purchase the carbon credit owned by the business operator A. The business operator A sells the carbon credit to the business operator B. Trading (buying and selling) between the business operator A and the business operator B may be performed directly or via an intermediary, or may be performed in the market. The sold carbon credit is utilized for, for example, a carbon offset. The carbon offset will be described later with reference to FIG. 2.

The business operator A distributes a part of a profit obtained by selling the carbon credit to each of the ordinary households participating in the project. In this way, even an ordinary household can participate in the carbon credit creation in cooperation with the business operator A, and can enjoy an incentive obtained due to the reduction of the greenhouse gas. The incentive leads to an improvement in motivation of the ordinary households to reduce the greenhouse gas, and as a result, can contribute to prevention of global warming.

FIG. 2 is a diagram illustrating an outline of the carbon offset. In the example illustrated in FIG. 2, it is assumed that the business operator A owns a factory, a building, or the like and is a business operator having a larger emission amount of CO2 than that of an ordinary household.

Graph (a) shown in FIG. 2 shows predictions of the emission amount of CO2 in the business operator A and the plurality of ordinary households when the project is not executed. Although the emission amount of CO2 in each ordinary household is much smaller than the emission amount of CO2 in the business operator A, a sum of the emission amounts of CO2 in the plurality of ordinary households can be on the order of the same level as the emission amount of CO2 in the business operator A.

Graph (b) in FIG. 2 shows actual values of the emission amount of CO2 and the reduction amount of CO2 in the business operator A and actual values of the emission amount of CO2 and the reduction amount of CO2 in the ordinary households when the project is executed. In the Graph (b), white portions correspond to the emission amounts of CO2, and hatched portions correspond to the reduction amounts of CO2.

Graph (c) in FIG. 2 is a graph in which the actual values of the emission amount of CO2 in the business operator A and the ordinary households are collected on a lower side of the Graph (b), and the actual values of the reduction amount of CO2 in the business operator A and the ordinary households are collected on an upper side of the Graph (b). In this way, the business operator A collects the own reduction amount of CO2 and the reduction amount of CO2 in the ordinary households.

Graphs (d-1), (d-2), and (d-3) in FIG. 2 show the emission amount of CO2 in the business operator B. It can be seen that the Graph (d-1) shows a prediction of the emission amount of CO2, the Graph (d-2) shows an actual value of the emission amount of CO2, and the actual value of the emission amount of CO2 in the business operator B exceeds the prediction. The business operator B can compensate for the excess emission amount of CO2 (that is, the carbon offset) shown in the Graph (d-3) by purchasing, from the business operator A, the carbon credit created based on the reduction amount of CO2 collected by the business operator A.

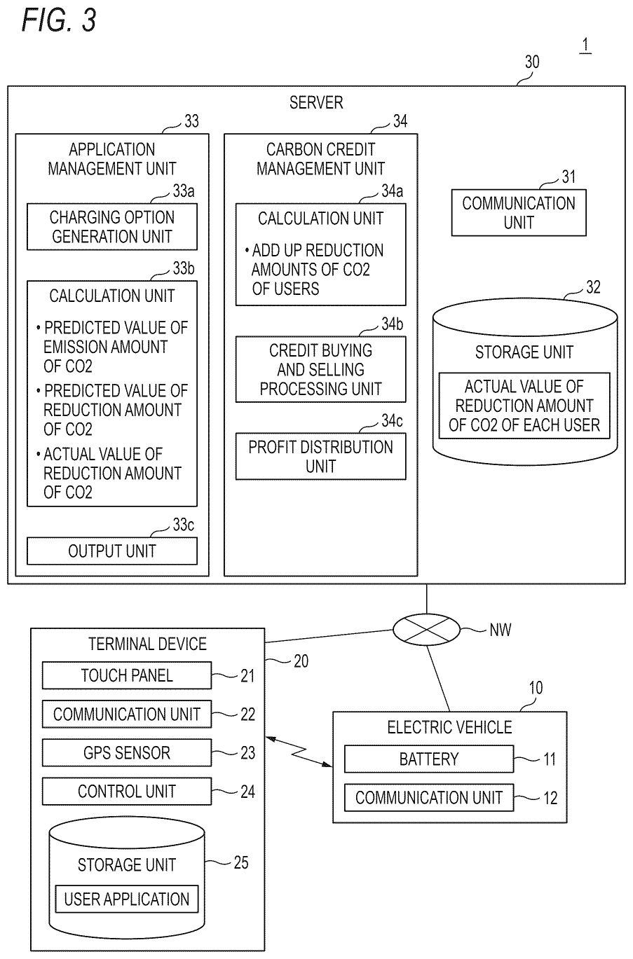

Next, the system 1 including the server 30 managed by the business operator A, and the electric vehicle 10 and the terminal device 20 owned by the ordinary household will be described with reference to FIG. 3. FIG. 3 is a block diagram showing a functional configuration of the system 1.

The system 1 includes the electric vehicle 10, the terminal device 20 used by an owner or a user of the electric vehicle 10, and the server 30. The server 30 is managed by the business operator A, and provides a service of a predetermined software application (hereinafter, also referred to as a user application) to ordinary households participating in a project organized by the business operator A. On the other hand, the terminal device 20 is a client that uses the service. Although only one electric vehicle 10 and one terminal device 20 are illustrated in FIG. 3, the system 1 includes the electric vehicles 10 and the terminal devices 20 owned or used by a plurality of ordinary households participating in the project. The ordinary household is a user of the user application provided by the server 30, and the ordinary household participating in the project is also referred to as a user U in the following description.

The electric vehicle 10 includes a high-voltage battery 11 capable of supplying electric power to a drive source of the electric vehicle 10, and a communication unit 12 capable of communicating with the terminal device 20 and/or the server 30 in a wireless or wired manner. The battery 11 is implemented by stacking a plurality of battery cells, and is, for example, a lithium ion battery or a nickel hydrogen battery. The electric vehicle 10 is a vehicle that can be charged with electric power from an external power supply.

The electric vehicle 10 may be configured to perform automatic charging in which a charging operation is automatically performed. For example, the electric vehicle 10 may be configured to automatically start charging at a preset time when plugged in a charging equipment. Further, the electric vehicle 10 may be configured to automatically drive (that is, autonomously move without driving by a driver) to a predetermined charging equipment and automatically start the charging. Hereinafter, automatically starting the charging may be referred to as automatic charging.

The terminal device 20 is, for example, a smartphone, a tablet terminal, or a personal computer (PC), and the above-described user application is installed therein. The terminal device 20 may be a navigation device or the like that is mounted on the electric vehicle 10 and in which the user application is installed. Here, a case where the terminal device 20 is a smartphone used by the user U will be described as an example.

The terminal device 20 includes a touch panel 21, a communication unit 22, a global positioning system (GPS) sensor 23, a control unit 24, and a storage unit 25.

The touch panel 21 functions as an interface unit of the terminal device 20. Specifically, the touch panel 21 includes, as functions related to input and output of the terminal device 20, an information display unit that displays various types of information to the user U and an information input unit that receives input of information by a touch operation of the user U.

The communication unit 22 includes a short-range communication unit that wirelessly communicates with the electric vehicle 10 based on a communication standard such as Bluetooth (registered trademark) or Wi-Fi (registered trademark), and a network communication unit that wirelessly communicates with the server 30 via a network NW by mobile communication, for example. The short-range communication unit may be configured to perform wired communication with the electric vehicle 10 by USB (Universal Serial Bus) or the like.

The GPS sensor 23 receives a signal transmitted from a GPS satellite and acquires position information of the terminal device 20, specifically, latitude and longitude.

In the control unit 24, a processor such as a central processing unit (CPU) capable of executing various calculations executes the user application stored in the storage unit 25 such as a read only memory (ROM) that stores various types of information. The user application is downloaded in advance by the user U and is stored in the storage unit 25.

The server 30 processes information on the carbon credit. The server 30 is a remote computer capable of communicating with the terminal device 20, which is a local terminal, and/or the electric vehicle 10 via the network NW. The server 30 may be a distributed server including a plurality of servers or a distributed virtual server (cloud server) created in a cloud environment.

The server 30 includes a communication unit 31, a storage unit 32, an application management unit 33 that manages user applications, and a carbon credit management unit 34 which manages the carbon credit.

The communication unit 31 is configured to wirelessly communicate with the terminal device 20 and/or the electric vehicle 10 via the network NW.

The storage unit 32 stores various types of information received from the terminal device 20 and stores various types of information calculated by the application management unit 33 and the carbon credit management unit 34. In the illustrated example, an actual value of the reduction amount of CO2 of each user U is stored in the storage unit 32.

The application management unit 33 manages a user application for supporting the carbon credit creation performed by the user U. The user application has, for example, a function of proposing, to the user U, a charging action of the electric vehicle 10 contributing to a reduction in the emission amount of CO2 and a function of managing an acquired actual charging result and the like. When the terminal device 20 is logged in to the server 30, the application management unit 33 communicates with the terminal device 20, transmits predetermined display information to the terminal device 20, and displays a screen on the user application.

The application management unit 33 includes a charging option generation unit 33a that generates a charging option to be described later, a calculation unit 33b that performs predetermined calculation processing to calculate a predicted value of the emission amount of CO2, a predicted value of the reduction amount of CO2, and the like, and an output unit 33c that outputs display information for causing the terminal device 20 to display the charging option generated by the charging option generation unit 33a, a calculation result of the calculation unit 33b, and the like.

The carbon credit management unit 34 performs, for example, processing of information necessary for applying for the carbon credit and processing for utilizing (buying and selling) the issued carbon credit, and manages the carbon credit. The carbon credit management unit 34 includes a calculation unit 34a that calculates a total value or the like obtained by adding up the reduction amounts of CO2 of a plurality of users U, a credit buying and selling processing unit 34b that performs processing during buying and selling of the carbon credit, and a profit distribution unit 34c that performs processing for distributing a part of the profit, obtained by selling the carbon credit, to each of the users U as an incentive.

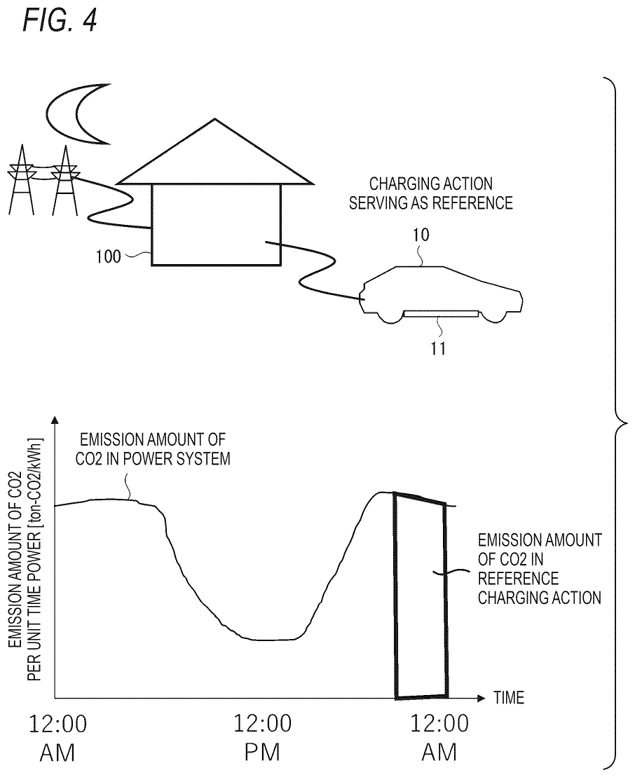

Next, the generation of the charging option performed by the application management unit 33 of the server 30 will be described with reference to FIGS. 4 to 11. In the present description, charging the battery 11 mounted on the electric vehicle 10 using the external power supply is also referred to as “charging action”. The charging action includes the automatic charging described above in addition to the user U of the electric vehicle 10 manually performing charging.

The server 30 generates a candidate of another charging action (charging option) having a smaller emission amount of CO2 than that in a charging action serving as a reference (reference charging action). he server 30 generates the charging option, for example, based on position information of the electric vehicle 10 or the terminal device 20. In the present embodiment, for example, as shown in FIG. 4, a case where the reference charging action is an action of charging the electric vehicle 10 with electric power supplied from the power system at a home 100 at night will be described as an example.

The graph shown in FIG. 4 shows an example of a time history of the predicted value of the emission amount of CO2 per unit time power in the power system. Information contained in the graph is acquired, for example, by the server 30 performing predetermined processing based on information provided by the electric power company or the like. In the daytime, since a power generation amount generated by solar power generation is large, a ratio of the power generation amount generated by solar power generation or the like among an amount of power generated by the electric power company is relatively large, and the emission amount of CO2 per unit time power is small. On the other hand, at night, since the power generation amount generated by solar power generation is small, a ratio of a power generation method with a larger emission amount of CO2 such as thermal power generation increases, and the emission amount of CO2 per unit time power increases.

When the electric vehicle 10 is charged with the electric power supplied from the power system at the home 100 at night, the emission amount of CO2 corresponding to a region surrounded by the thick line in the graph is expected. Specifically, the emission amount of CO2 corresponding to the region is calculated by multiplying the predicted value [ton-CO2/kWh] of the emission amount of CO2 per unit time power by the charged power amount [kWh]. In this way, the server 30 can calculate the emission amount of CO2 estimated to be emitted due to the charging of the electric vehicle 10, based on the emission amount of CO2 per unit time power in the power system and the charged power amount. The calculation method of the emission amount of CO2 described here is merely an example, and the emission amount of CO2 can be calculated by various methods.

The server 30 generates a plurality of charging options in which the emission amount of CO2 is expected to be reduced as compared with the predicted value of the emission amount of CO2 in the reference charging action and proposes the charging options to the terminal device 20 in a predetermined manner.

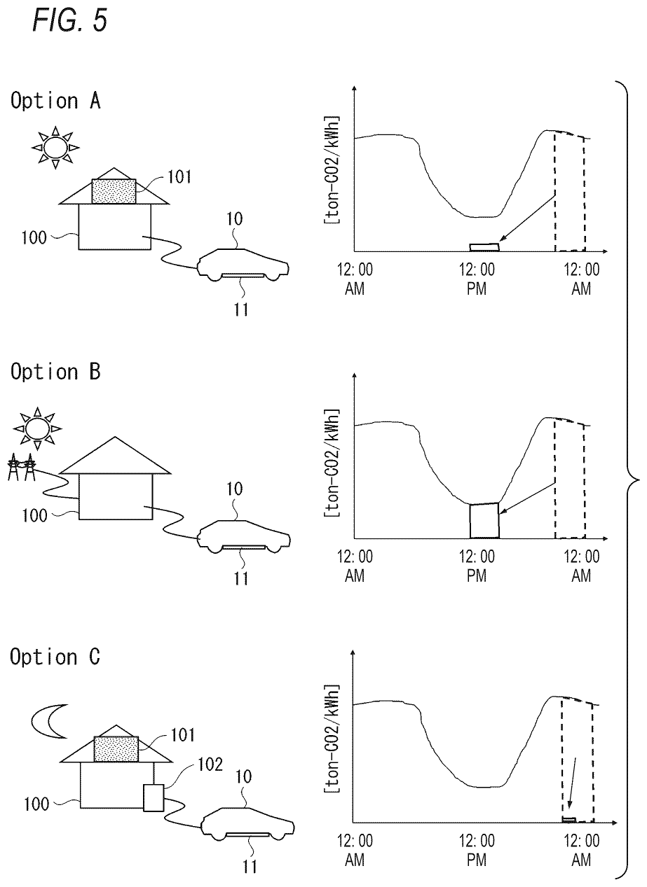

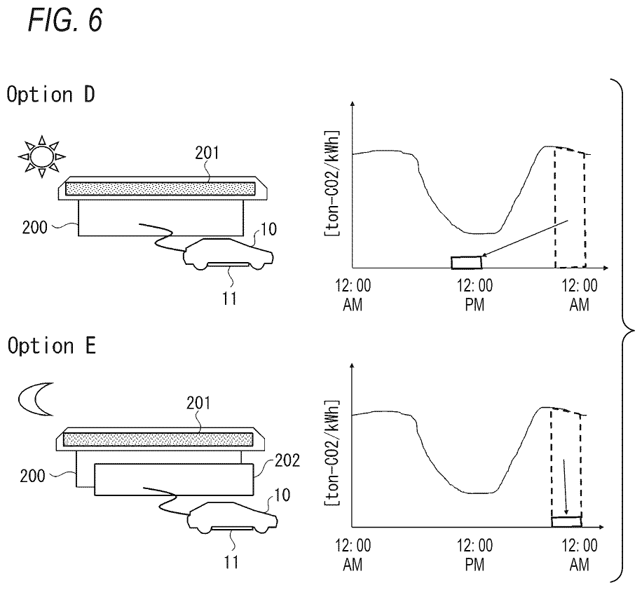

Charging options A to E will be described as examples of charging options of the present embodiment with reference to FIGS. 5 and 6. The charging options A to E are merely examples, and the server 30 can generate various charging options.

The charging option A is a charging action performed at the home 100 in the daytime, and is a charging action of charging the electric vehicle 10 with electric power generated by a solar panel 101 installed in the home 100. Since the electric vehicle 10 is charged using the electric power generated by solar power generation, the emission amount of CO2 per unit time power is zero, and the emission amount of CO2 emitted due to the charging of the electric vehicle 10 is zero. In a case where the power amount for charging the electric vehicle 10 cannot be covered only by the electric power generated by the solar power generation, since the electric power supplied from the power system may be used, in the charging option A, the emission amount of CO2 per unit time power is not necessarily zero, and as a result, the calculated emission amount of CO2 may take a value larger than zero. The same applies to the charging options C, D, and E to be described later.

The charging option B is a charging action performed at home in the daytime and is a charging action of charging the electric vehicle 10 with electric power supplied from the power system. Since the charging option B is a charging action performed in a time zone in which the emission amount of CO2 per unit time power in the power system is small, even if the charged power amount is the same as that in the reference charging action, the emission amount of CO2 is smaller than that in the reference charging action.

The charging option C is a charging action performed at home at night, and is a charging action of charging the electric vehicle 10 with electric power stored in a power storage device 102 installed in the home 100. The power storage device 102 stores electric power generated in the daytime by the solar panel 101 installed in the home 100, for example. Since the charging option C is a charging action of charging the electric vehicle 10 using the electric power originally generated by the solar panel 101, a reduction in the emission amount of CO2 can be expected.

The charging option D is a charging action performed at a charging station 200 (for example, an off-grid charging station) in a place different from the home 100 in the daytime, and is, for example, a charging action of charging the electric vehicle 10 with electric power generate by a solar panel 201 or the like installed in the charging station 200. Since the charging action is to charge the electric vehicle 10 using electric power generated by the solar panel 201 or the like, a reduction in the emission amount of CO2 can be expected. The charging station 200 may include another renewable energy facility such as a wind power generation facility.

The charging option E is a charging action performed at the charging station 200 at a place different from the home 100 at night, and is a charging action of charging the electric vehicle 10 with the electric power generated by the solar panel 201 or the like and the electric power stored in the power storage device 202 installed in the charging station 200 in the daytime. Since the charging action is to charge the electric vehicle 10 using the electric power originally generated by the solar panel 201 or the like, a reduction in the emission amount of CO2 can be expected.

In this way, the charging options generated by the server 30 include a charging action performed at a time and/or a place different from that of the reference charging action, a charging action of charging with electric power supplied from a power supply source different from that of the reference charging action, and the like.

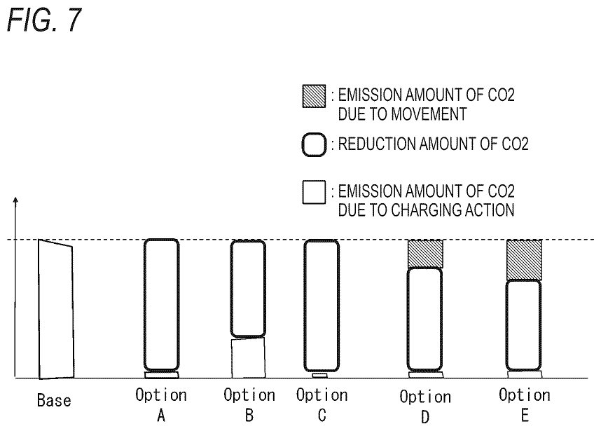

FIG. 7 is a bar graph showing the emission amounts of CO2 and the reduction amounts of CO2 in the reference charging action (denoted as “Base” in the drawing) and the charging actions in the charging options A to E. The emission amount of CO2 and the reduction amount of CO2 here are not actual values but predicted values calculated by the server 30.

In the charging options A, B, and C, the server 30 calculates the reduction amount of CO2 by subtracting the emission amount of CO2 in the charging action of each of the charging options A, B, and C from the emission amount of CO2 in the reference charging action.

In the charging options D and E, the server 30 calculates the reduction amount of CO2 by subtracting the emission amount of CO2 in the charging action in each of the charging options D and E from the emission amount of CO2 in the reference charging action and then subtracting the emission amount of CO2 caused by movement of the electric vehicle from an obtained value. This is because, in the charging options D and E, since the charging is performed at the charging station 200 which is a place different from the home 100, it is necessary to consider the emission amount of CO2 for charging the power amount of the battery 11 consumed by the movement of the electric vehicle 10 between the home 100 and the charging station 200. The server 30 calculates the emission amount of CO2 caused by the movement of the electric vehicle 10 based on a movement distance between the home 100 and the charging station 200, power consumption, and the like.

In this way, since the server 30 automatically calculates the predicted value of the reduction amount of CO2 in each charging option based on the predicted value of the emission amount of CO2 in the reference charging action and the predicted value of the emission amount of CO2 in the charging option, a charging option contributing to a reduction of CO2 can be proposed to the user U.

In a case where there are a plurality of charging stations in the vicinity of the home 100, when server 30 proposes a charging action to be performed at a charging station at a place different from the home 100 as in the charging options D and E, server 30 may determine a charging station to be proposed to the user U based on an electricity cost.

The server 30 displays a screen for proposing the generated charging options A to E to the user U on the terminal device 20 in which the user application is activated. Thus, the server 30 can encourage the user U to change to a charging action having a smaller emission amount of CO2.

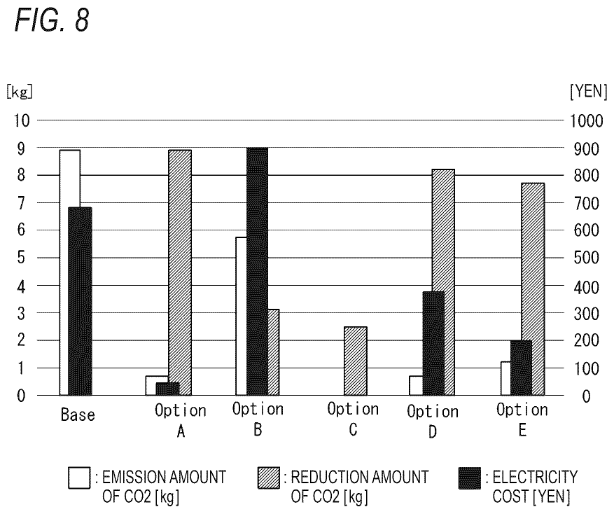

FIG. 8 is an example of a proposal screen of the charging options A to E displayed on the terminal device 20. The server 30 visually displays the emission amount of CO2, the reduction amount of CO2, and an electricity cost for charging, for the reference charging action and the charging actions in the charging options A to E. Here, an example in which the emission amount of CO2, the reduction amount of CO2, and the electricity cost are displayed in a bar graph is shown.

In this way, since the server 30 visually displays, for each charging option, the emission amount of CO2 and the reduction amount of CO2 on the terminal device 20, the user U can easily grasp an effect of reducing the emission amount of CO2 by changing the charging action. In addition, since the server 30 visually displays the electricity cost for the reference charging action and each charging option, a charging action with a high profit can be proposed to the user U. The server 30 does not need to display all of the emission amount of CO2, the reduction amount of CO2, and the electricity cost for each charging option on the terminal device 20, and may be configured to display at least one of these.

Further, by selecting the charging option proposed by the server 30 and reducing the emission amount of CO2, the user U can consequently receive an incentive from the business operator A. Therefore, the motivation of the user U who performs an action contributing to the prevention of global warming can be improved.

Further, the server 30 may display a chargeable power amount of each charging option on the terminal device 20 in which the user application is activated.

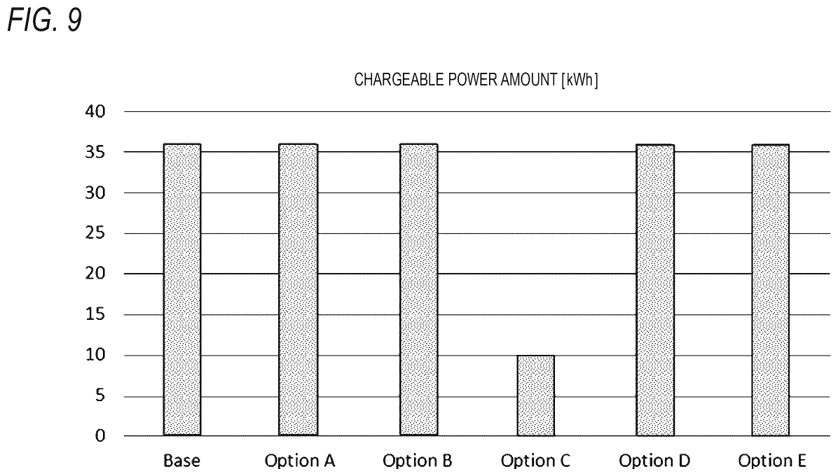

FIG. 9 is an example of a screen visually showing chargeable power amounts in the reference charging action and each of the charging options A to E displayed on the terminal device 20. For example, in the charging option C, when the power amount stored in the power storage device 102 is small, the chargeable power amount in the charging option C is displayed to be low. In this way, by displaying the chargeable power amounts in the charging options A to E, resources for the user U to select one of the charging options can be enhanced.

When calculating the reduction amount of CO2 in the charging option for charging the battery 11 with the electric power (including the electric power stored in the power storage devices 102 and 202) generated by the solar power generation such as the charging options C to E, the server 30 may calculate the reduction amount of CO2 further based on meteorological data provided from a meteorology server or the like (not shown). The meteorological data here includes at least one of past meteorological data and future (predicted) meteorological data.

Specifically, the server 30 may calculate the reduction amount of CO2 by multiplying a value obtained by subtracting the emission amount of CO2 in the charging option from the emission amount of CO2 in the reference charging action by a predetermined weather coefficient obtained from the meteorological data. For example, the higher a probability that the weather is good (sunny), the higher the weather coefficient, and the higher a probability that the weather is bad (cloudy, rainy, or the like), the lower the weather coefficient.

As described above, since the server 30 calculates the reduction amount of CO2 caused by solar power generation, which is likely to depend on weather, further based on meteorological data, the reduction amount of CO2 can be calculated with higher accuracy.

The server 30 may display information that can be acquired based on the meteorological data on the terminal device 20. For example, when proposing a charging option for charging the battery 11 with electric power generated by the solar power generation, the server 30 may display, on the terminal device 20, a charging power amount charged to the battery 11 by the solar power generation estimated based on the meteorological data. When proposing a charging option for charging the battery 11 with electric power generated by the solar power generation, the server 30 may display, on the terminal device 20, the power generation amount generated by the solar power generation and estimated based on the meteorological data. Thus, the user U can grasp whether the battery 11 can be sufficiently charged by the power amount obtained by the solar power generation depending on weather.

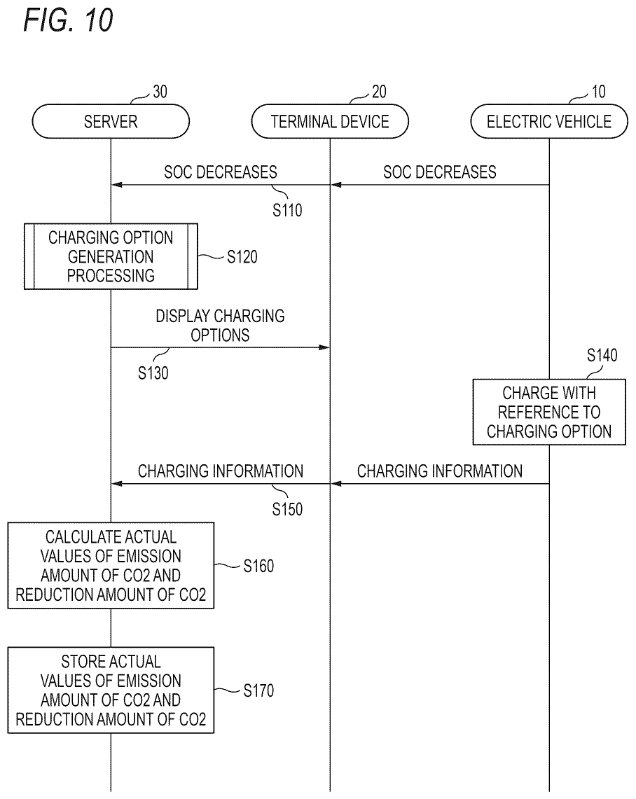

FIG. 10 is a sequence diagram showing an example of processing performed among the server 30, the terminal device 20, and the electric vehicle 10.

In a state where the electric vehicle 10 can communicate with the server 30, the electric vehicle 10 transmits information on a state of charge (SOC) of the battery 11 to the server 30 at predetermined time intervals (step S110). The electric vehicle 10 may transmit the SOC of the battery 11 to the server 30 via the terminal device 20.

When server 30 determines that the SOC of battery 11 decreases, specifically, the SOC of battery 11 becomes lower than a predetermined threshold (for example, 30%), the server 30 performs processing of generating a charging option (also referred to as charging option generation processing) (step S120). The server 30 may be configured to perform the charging option generation processing when it is predicted based on a travel plan set in advance in the electric vehicle 10 that the SOC of the battery 11 is less than a predetermined threshold (that is, when it is predicted that charging the battery 11 in advance is necessary) in a case where the electric vehicle 10 travels according to the travel plan.

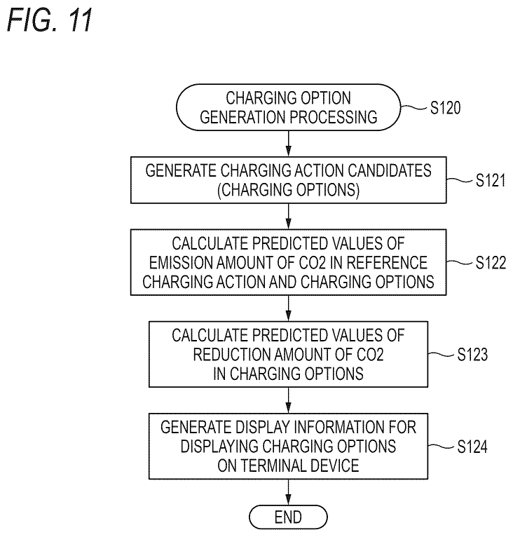

FIG. 11 is a flowchart showing an example of the charging option generation processing. The server 30 generates a plurality of charging action candidates that can be proposed to the user U of the electric vehicle 10 as charging options (step S121) and calculates the predicted values of the emission amount of CO2 in the respective charging options (step S122).

Then, the server 30 calculates the predicted value of the reduction amount of CO2 in each charging option based on the predicted value of the emission amount of CO2 in the reference charging action and the predicted value of the emission amount of CO2 in the charging option which is another charging action (step S123). Specifically, the predicted value of the reduction amount of CO2 in each charging option is calculated by subtracting the predicted value of the emission amount of CO2 in each charging option from the predicted value of the emission amount of CO2 in the reference charging action. After calculating the predicted value of the reduction amount of CO2, the server 30 generates display information for displaying the charging option on the terminal device 20 together with the emission amount of CO2 and the reduction amount of CO2 (step S124).

Returning to FIG. 10, the server 30 transmits the display information generated in step S124 to the terminal device 20 and displays each charging option selectable by the user U together with the emission amount of CO2 and the reduction amount of CO2 on the terminal device 20 in which the user application is activated (step S130).

The user U causes the electric vehicle 10 to be charged with reference to the charging option displayed on the terminal device 20 (step S140). The charging action performed by the electric vehicle 10 is not limited to the charging option proposed by the server 30 and may naturally be the reference charging action or another charging action.

After completion of the charging, the electric vehicle 10 transmits predetermined charging information to the server 30 (step S150). The predetermined charging information includes a charged power amount, a charging time, a charging place, a charging time zone, a charging mode (electric power from the power system, electric power generated by solar power generation, or electric power from the power storage device), and the like. The electric vehicle 10 may directly transmit the predetermined charging information to the server 30, or may transmit the predetermined charging information to the server 30 via the terminal device 20.

The server 30 calculates the actual values of the emission amount of CO2 and the reduction amount of CO2 in the actually performed charging action based on the charging information transmitted from the electric vehicle 10 (step S160) and stores the actual values in the storage unit 32 (step S170). Specifically, the server 30 specifies a place where the electric vehicle 10 is actually charged based on position information of the electric vehicle 10 or position information of the terminal device 20. Then, the server 30 calculates the emission amount of CO2 per unit time power at the charging place based on the information provided by the electric power company or the like and calculates the actual values of the emission amount of CO2 and the reduction amount of CO2 in the actually performed charging action based on the emission amount of CO2 per unit time power, the charged power amount, and the like. Although details will be described later, the carbon credit is created based on the actual value of the reduction amount of CO2. The server 30 may display the actual values of the emission amount of CO2 and the reduction amount of CO2 on the terminal device 20 in which the user application is activated.

The processing shown in FIG. 10 is repeatedly performed for the electric vehicles owned or used by a plurality of users U during a predetermined monitoring period (for example, one month or one year). The server 30 integrates, for each user U, the actual values of the reduction amount of CO2 in a plurality of charging actions actually performed during the monitoring period.

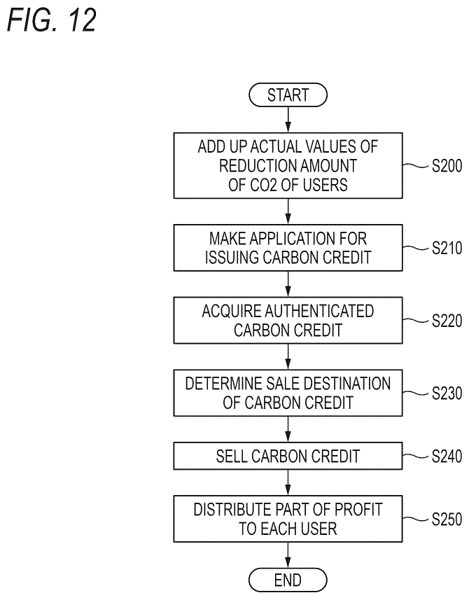

FIG. 12 is a control flow showing an example of processing for carbon credit management performed by the server 30. After the monitoring period has elapsed, the server adds up the actual values of the reduction amount of CO2 for each user U accumulated during the monitoring period (step S200).

The server 30 makes an application for issuing the carbon credit to the authentication institution based on the added actual values of the reduction amount of CO2 (step S210). When the authentication of the carbon credit is completed by the authentication institution, the server 30 acquires the authenticated carbon credit (step S220).

When selling the carbon credit as the utilization, the server 30 determines a sale destination of the carbon credit (step S230) and performs processing of selling the carbon credit (step S240). The processing in step S240 is automatically performed by the server 30.

After selling the carbon credit, the server 30 distributes a part of a profit obtained by the selling to each user U (step S250). The processing in step S250 is automatically performed by the server 30. Thus, the user U can enjoy the incentive given by participating in the project for reducing the emission of the greenhouse gas by the business operator A and contributing to the reduction of CO2. At this time, the server 30 determines the incentive to be distributed to each user U based on, for example, the reduction amount of CO2 of each user U.

### Modification

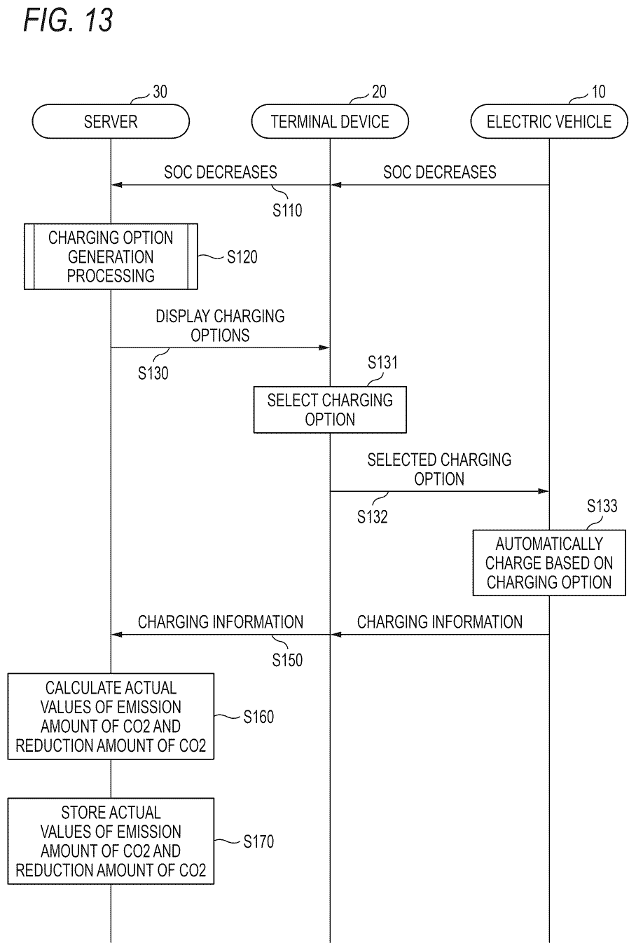

FIG. 13 is a sequence diagram showing a modification of the processing performed among the server 30, the terminal device 20, and the electric vehicle 10. In the present modification, the electric vehicle 10 performs automatic charging based on the charging option selected by the user U. Since steps S110 to S130 and steps S150 to S170 are the same as those in FIG. 10, the description thereof will be omitted.

After the server 30 displays the charging option on the terminal device 20 (step S130), the user U selects one charging option from among the plurality of charging options displayed on the terminal device 20, and inputs selection of the charging option to the terminal device 20 (step S131).

The terminal device 20 transmits the charging option selected by the user U to the electric vehicle 10 (step S132), and the electric vehicle 10 performs automatic charging based on the charging option (step S133). For example, when the user U selects the above-described charging option E and the electric vehicle 10 is at the home 100, the electric vehicle 10 travels to the charging station 200 by autonomous driving at night and automatically starts charging. The server 30 that recognizes the charging option selected by the user U may transmit the charging option to the electric vehicle 10. In this case, the server 30 may be configured to remotely operate the electric vehicle 10 to automatically charge the electric vehicle 10.

The information processing method described above can be implemented by causing a computer to execute a program prepared in advance. The program is stored in a computer-readable storage medium and executed by being read from the storage medium. In addition, the program may be provided in a form stored in a non-transitory storage medium such as a flash memory, or may be provided via a network such as the Internet. In addition to the server 30, the computer that executes the program may be the terminal device 20 that downloads the program from the server 30, a control device (for example, an electronic control unit (ECU)) that is mounted on the electric vehicle 10 and downloads the program from the server 30, or a combination thereof.

Although an embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiments may be freely combined without departing from the gist of the invention.

For example, in the above-described embodiment, an example in which the server performs the charging option generation processing (step S120) and the calculation of the actual values of the emission amount of CO2 and the reduction amount of CO2 (step S160) has been described with reference to FIG. 10, but the present disclosure is not limited thereto. For example, these processes may be performed by the terminal device 20 and/or a control device mounted on the electric vehicle 10. However, when the server 30 performs the charging option generation processing (step S120) and the calculation of the actual values of the emission amount of CO2 and the reduction amount of CO2 (step S160), a processing load can be reduced as compared with the case where the terminal device 20 or the control device of the electric vehicle 10 performs these processes. As a result, power consumption of the terminal device 20 or the electric vehicle 10 can be reduced.

Further, the authentication institution may not permit the creation (application) of the carbon credit based on the power amount used for traveling of the electric vehicle 10 among the power amount charged in the battery 11. Therefore, the carbon credit may be created based on a power amount excluding the power amount used for traveling of the electric vehicle 10 after the charging action among the power amount charged to the battery 11 by the actually performed charging action. Specifically, the carbon credit may be created based on the power amount used for power supply to the home, the power system, or the like among the power amount charged to the battery 11 by the actually performed charging action. More specifically, the server 30 calculates the reduction amount of CO2 corresponding to the power amount used for power supply to the home, the power system, or the like, and uses the reduction amount of CO2 as data at the time of applying for the carbon credit.

In the present specification, at least the following matters are described. In the parentheses, the corresponding constituent elements and the like in the above embodiment are shown as an example, but the present invention is not limited thereto.

(1) An information processing method, which a computer (server 30) performs, of processing information on a carbon credit created by reducing greenhouse gas,
the carbon credit being created based on a reduction of the greenhouse gas discharged by a charging action of charging a battery (battery 11) mounted on an electric vehicle (electric vehicle 10) from by an external power supply, and
the information processing method including:
   a generation step (step S121) of generating a charging action candidate including at least one another charging action different from a reference charging action that is a charging action serving as a reference, the at least one another charging action having an emission amount of the greenhouse gas smaller than that in the reference charging action, the charging action candidate being selectable by a user of the electric vehicle;
   an emission amount calculation step (step S122) of calculating a predicted value of an emission amount of the greenhouse gas discharged by each of the charging actions; and
   a reduction amount calculation step (step S123) of calculating a predicted value of a reduction amount of the greenhouse gas in each of the at least one another charging action, based on the predicted value of the emission amount of the greenhouse gas in the reference charging action and the predicted value of the emission amount of the greenhouse gas in the another charging action.

According to (1), a charging action contributing to the reduction of the greenhouse gas can be proposed to the user of the electric vehicle, and the creation of the carbon credit using the electric vehicle can be supported. This contributes to prevention of global warming.

(2) The information processing method according to (1), further including:
a displaying step (step S130) of displaying the charging action candidate on a terminal device (terminal device 20) of the user or a terminal device mounted on the electric vehicle,
in which in the displaying step, at least one of a predicted value of an emission amount of the greenhouse gas and a predicted value of a reduction amount of the greenhouse gas is displayed on the terminal device together with the charging action candidate.

According to (2), the user can visually confirm the emission amount and/or the reduction amount of the greenhouse gas in each charging action.

(3) The information processing method according to (1),
in which the at least one another charging action includes a charging action performed at another time and/or another place different from a time and/or a place at which the reference charging action is performed.

According to (3), a charging action that can contribute to the reduction of the greenhouse gas by changing the time and/or place can be proposed to the user.

(4) The information processing method according to (3),
in which the at least one another charging action includes a charging action performed at another place different from the place where the reference charging action is performed, and
in the reduction amount calculation step, a predicted value of a reduction amount of the greenhouse gas in the charging action performed at the another place is calculated further based on an emission amount of the greenhouse gas caused by a movement of the electric vehicle between the place where the reference charging action is performed and the another place.

According to (4), since the emission amount of greenhouse gas caused by the movement of the electric vehicle is considered, the predicted value of the emission amount of the greenhouse gas can be accurately calculated.

(5) The information processing method according to (1),
in which the at least one another charging action includes a charging action of charging the battery with electric power generated by solar power generation, and
in the reduction amount calculation step, a predicted value of a reduction amount of the greenhouse gas in the charging action using the solar power generation is calculated further based on meteorological data.

According to (5), since the predicted value of the reduction amount of the greenhouse gas by solar power generation, which is likely to depend on weather, is calculated further based on the meteorological data, the predicted value of the reduction amount of the greenhouse gas can be calculated with higher accuracy.

(6) The information processing method according to (5), further including:
a displaying step (step S130) of displaying the charging action candidate on a terminal device (terminal device 20) of the user or a terminal device mounted on the electric vehicle,
in which in the displaying step, at least one of
   information on a power amount charged to the battery by the solar power generation, the power amount being estimated based on the meteorological data, and
   information on a power generation amount generated by the solar power generation, the power generation amount being estimated based on the meteorological data
is further displayed on the terminal device together with the charging action candidate.

According to (6), information specific to the solar power generation can be displayed on the terminal device.

(7) The information processing method according to any one of (1) to (6), further including:
an actual reduction amount calculation step (step S160) of calculating an actual value of a reduction amount of the greenhouse gas based on an actual value of an emission amount of the greenhouse gas in an actually performed charging action and the predicted value of the emission amount of the greenhouse gas in the reference charging action,
in which the carbon credit is created based on the actual value of the reduction amount of the greenhouse gas.

According to (7), a highly reliable carbon credit based on the actual value of the reduction amount of the greenhouse gas can be created.

(8) The information processing method according to (7),
in which the carbon credit is created based on the actual value of the reduction amount of the greenhouse gas accumulated in a predetermined period.

According to (8), although the reduction amount of the greenhouse gas per charging action is relatively small, the carbon credit can be created based on a sufficient reduction amount of the greenhouse gas by integrating the reduction amount for a predetermined period.

(9) The information processing method according to (7),
in which the carbon credit is created based on a power amount excluding a power amount used for traveling of the electric vehicle after the charging action among a power amount charged to the battery by the actually performed charging action.

According to (9), the power amount used for traveling of the electric vehicle after the charging action can be excluded from the data used for creating the carbon credit.

(10) A non-transitory computer-readable storage medium storing a program for processing information on a carbon credit created by reducing greenhouse gas,
the carbon credit being created based on a reduction of the greenhouse gas discharged by a charging action of charging a battery (battery 11) mounted on an electric vehicle (electric vehicle 10) by an external power supply,
the program causing a computer to perform:
   a generation step (step S121) of generating a charging action candidate including at least one another charging action a reference charging action that is a charging action serving as a reference, the at least one another charging action having an emission amount of the greenhouse gas smaller than that in the reference charging action, the charging action candidate being selectable by a user of the electric vehicle;
   an emission amount calculation step (step S122) of calculating a predicted value of an emission amount of the greenhouse gas discharged by each of the charging actions; and
   a reduction amount calculation step (step S123) of calculating a predicted value of a reduction amount of the greenhouse gas in each of the at least one another charging action, based on the predicted value of the emission amount of the greenhouse gas in the reference charging action and the predicted value of the emission amount of the greenhouse gas in the another charging action.

According to (10), a charging action contributing to the reduction of the greenhouse gas can be proposed to the user of the electric vehicle, and the creation of carbon credit using the electric vehicle can be supported. This contributes to the prevention of global warming.

(11) An information processing method, which a computer (server 30) performs, of processing information on a carbon credit created by reducing greenhouse gas,
the carbon credit being created based on a reduction of the greenhouse gas discharged by a charging action of charging a battery (battery 11) mounted on each of a plurality of electric vehicles (electric vehicle 10) by an external power supply, and
the information processing method including:
   an add-up step (step S200) of calculating an actual value of a reduction amount of the greenhouse gas for each of users of the plurality of electric vehicles, the actual value of the reduction amount of the greenhouse gas being calculated based on a predicted value of an emission amount of the greenhouse gas in a reference charging action that is a charging action serving as a reference, and an actual value of an emission amount of the greenhouse gas when another charging action having an emission amount of the greenhouse gas smaller than that in the reference charging action is actually performed, and adding up the actual values of the reduction amount of the greenhouse gas;
   a selling step (step S240) of performing processing of selling the carbon credit created based on a sum of the actual values of the reduction amount of the greenhouse gas; and
   a distribution step (step S250) of distributing a part of a profit obtained in the selling step to each of the users.

According to (11), since the computer performs the processing of distributing a part of the profit obtained by selling the carbon credit to the user, it is possible to encourage the user to perform a charging action for reducing the greenhouse gas and to contribute to the prevention of global warming.

What is claimed is:

1. An information processing method, which a computer performs, of processing information on a carbon credit created by reducing greenhouse gas,
the carbon credit being created based on a reduction of the greenhouse gas discharged by a charging action of charging a battery mounted on an electric vehicle by an external power supply, and
the information processing method comprising:
generating a charging action candidate including at least one another charging action different from a reference charging action that is a charging action serving as a reference, the at least one another charging action having an emission amount of the greenhouse gas smaller than that in the reference charging action, the charging action candidate being selectable by a user of the electric vehicle;
calculating a predicted value of an emission amount of the greenhouse gas discharged by each of the charging actions; and
calculating a predicted value of a reduction amount of the greenhouse gas in each of the at least one another charging action, based on the predicted value of the emission amount of the greenhouse gas in the reference charging action and the predicted value of the emission amount of the greenhouse gas in the another charging action.

2. The information processing method according to claim 1, further comprising:
displaying the charging action candidate on a terminal device of the user or a terminal device mounted on the electric vehicle,
wherein in the displaying, at least one of a predicted value of an emission amount of the greenhouse gas and a predicted value of a reduction amount of the greenhouse gas is displayed on the terminal device together with the charging action candidate.

3. The information processing method according to claim 1,
wherein the at least one another charging action includes a charging action performed at another time and/or another place different from a time and/or a place at which the reference charging action is performed.

4. The information processing method according to claim 3,
wherein the at least one another charging action includes a charging action performed at another place different from the place where the reference charging action is performed, and
in the calculation of the predicted reduction amount, a predicted value of a reduction amount of the greenhouse gas in the charging action performed at the another place is calculated further based on an emission amount of the greenhouse gas caused by a movement of the electric vehicle between the place where the reference charging action is performed and the another place.

5. The information processing method according to claim 1,
wherein the at least one another charging action includes a charging action of charging the battery with electric power generated by solar power generation, and
in the calculation of the predicted reduction amount, a predicted value of a reduction amount of the greenhouse gas in the charging action using the solar power generation is calculated further based on meteorological data.

6. The information processing method according to claim 5, further comprising:
displaying the charging action candidate on a terminal device of the user or a terminal device mounted on the electric vehicle,
wherein in the displaying, at least one of
information on a power amount charged to the battery by the solar power generation, the power amount being estimated based on the meteorological data, and
information on a power generation amount generated by the solar power generation, the power generation amount being estimated based on the meteorological data
is further displayed on the terminal device together with the charging action candidate.

7. The information processing method according to claim 1, further comprising:
calculating an actual value of a reduction amount of the greenhouse gas based on an actual value of an emission amount of the greenhouse gas in an actually performed charging action and the predicted value of the emission amount of the greenhouse gas in the reference charging action,
wherein the carbon credit is created based on the actual value of the reduction amount of the greenhouse gas.

8. The information processing method according to claim 7,
wherein the carbon credit is created based on the actual value of the reduction amount of the greenhouse gas accumulated in a predetermined period.

9. The information processing method according to claim 7,
wherein the carbon credit is created based on a power amount excluding a power amount used for traveling of the electric vehicle after the charging action among a power amount charged to the battery by the actually performed charging action.

10. A non-transitory computer-readable storage medium storing a program for processing information on a carbon credit created by reducing greenhouse gas,
the carbon credit being created based on a reduction of the greenhouse gas discharged by a charging action of charging a battery mounted on an electric vehicle by an external power supply, and
the program causing a computer to perform:
generating a charging action candidate including at least one another charging action different from a reference charging action that is a charging action serving as a reference, the at least one another charging action having an emission amount of the greenhouse gas smaller than that in the reference charging action, the charging action candidate being selectable by a user of the electric vehicle;
calculating a predicted value of an emission amount of the greenhouse gas discharged by each of the charging actions; and
calculating a predicted value of a reduction amount of the greenhouse gas in each of the at least one another charging action, based on the predicted value of the emission amount of the greenhouse gas in the reference charging action and the predicted value of the emission amount of the greenhouse gas in the another charging action.

11. An information processing method, which a computer performs, of processing information on a carbon credit created by reducing greenhouse gas,
the carbon credit being created based on a reduction of the greenhouse gas discharged by a charging action of charging a battery mounted on each of a plurality of electric vehicles by an external power supply, and
the information processing method comprising:
calculating an actual value of a reduction amount of the greenhouse gas for each of users of the plurality of electric vehicles, the actual value of the reduction amount of the greenhouse gas being calculated based on a predicted value of an emission amount of the greenhouse gas in a reference charging action that is a charging action serving as a reference, and an actual value of an emission amount of the greenhouse gas when another charging action having an emission amount of the greenhouse gas smaller than that in the reference charging action is actually performed, and adding up the actual values of the reduction amount of the greenhouse gas;
performing processing of selling the carbon credit created based on a sum of the actual values of the reduction amount of the greenhouse gas; and
distributing a part of a profit obtained in the selling of the carbon credit to each of the users.
